(19) United States
(12) Patent Application Publication
(10) Pub. No.: US 2007/0072058 A1
(43) Pub. Date: Mar. 29, 2007

(54) Fuel cell and electronic equipment with the same

(76) Inventors: Toru Koyama, Hitachi (JP); Shinsuke Andoh, Hitachi (JP); Kenichi Souma, Mito (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/527,413

(22) Filed: Sep. 27, 2006

(30) Foreign Application Priority Data
Sep. 28, 2005 (JP) 2005-281066

(51) Int. Cl. H01M 4/86; H01M 8/10; H01M 8/02

(52) U.S. Cl. 429/44; 429/45; 429/30; 429/38

(57) ABSTRACT

a passive type fuel cell is comprised of an anode for oxidizing a liquid fuel, a cathode for reducing oxygen, a solid polymer electrolytic membrane interposed between the anode and the cathode, a current-collector for collecting extract electrons accompanying the power generating reaction from the anode, a first porous material to supply the fuel to the anode, and a second porous member for feeding the fuel to the first porous member. The solid polymer electrolytic membrane, the anode, the current-collector, the first porous member, and the second porous member are layered in the above-listed order. The pore diameter of the first porous material is made smaller than that of the second porous material.

### CLAIM OF PRIORITTY

The present application claims priority from Japanese application serial No. 2005-281066 filed on Sep. 28, 2005, the content of which is hereby incorporated by reference into this application.

### FIELD OF THE INVENTION

The present invention relates to a fuel cell which uses a liquid fuel, and electronic equipment with the fuel cell.

### BACKGROUND OF THE INVENTION

A fuel cell using a liquid fuel can be classified broadly into two types in accordance with the means of feeding the fuel, namely so-called passive and active types. In the case of an active type fuel cell, energy is extracted from a liquid fuel by: forcibly feeding a liquid fuel to an anode with auxiliary machinery such as a pump; circulating the fuel via the anode; feeding air to a cathode or circulating via through a cathode; and separating produced water. In contrast, a passive type fuel cell does not require auxiliary machinery which is required in the case of the active type and, as a fuel feeding mechanism thereof, the fuel is fed to the anode for example by capillary force of a porous member as disclosed in JP-A No. 134292/2004.

### SUMMARY OF THE INVENTION

The present invention is to provide a fuel cell capable of generating electricity stably for a long period of time in a fuel cell which uses a liquid fuel.

In order to solve the above problem, the present inventors have variously studied. As a result, the present invention is configured as follows in a passive type fuel cell.

The fuel cell comprises an anode for oxidizing a liquid fuel, a cathode for reducing oxygen, a solid polymer electrolytic membrane interposed between the anode and the cathode, a current collector for collecting electrons produced at the anode, a first porous member for feeding the fuel to the anode, and a second porous member for feeding the fuel to the first porous member. Furthermore, the solid polymer electrolytic membrane, the anode, the current collector, the first porous member, and the second porous member are arranged in the above-listed order; and the pore diameter of the first porous member is smaller than that of the second porous material.

Thus the present invention makes it possible for a fuel cell to generate electricity stably for a long period of time.

### BRIEF DESCRIPTION OF THE DRAWINGS

FIG. 1 is an exploded view of a fuel cell according to the present invention.

FIG. 2 is a general perspective view of the fuel cell.

FIG. 3 is a perspective view showing the state wherein the cathode end plate is removed from the fuel cell shown in FIG. 2.

FIG. 4 is a graph showing the relationship between a suction height and a pore diameter according to the present invention.

FIG. 5 is a view showing the anode end plate of the fuel cell.

FIG. 6 is a view showing a cellular phone with the fuel cell.

FIG. 7 is a view showing a notebook personal computer with the fuel cell.

### DETAILED DESCRIPTION OF THE PREFERRED EMBODIMENTS

Embodiments of the present invention are hereunder explained in reference to drawings. A fuel cell in the present embodiments is a so-called direct-type methanol fuel cell which uses methanol as the liquid fuel.

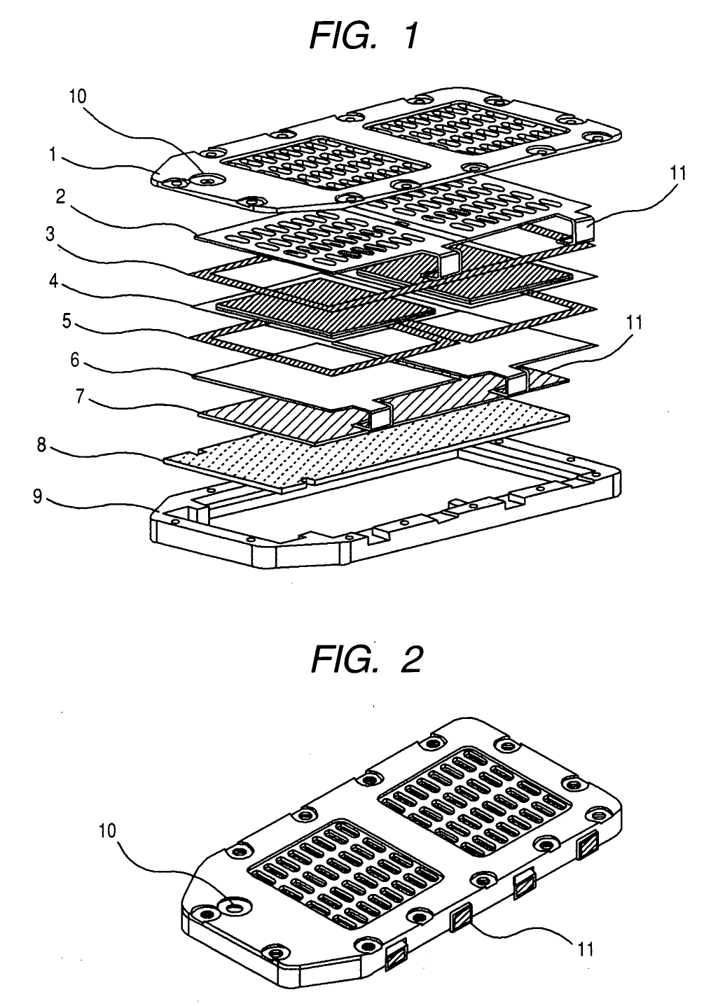

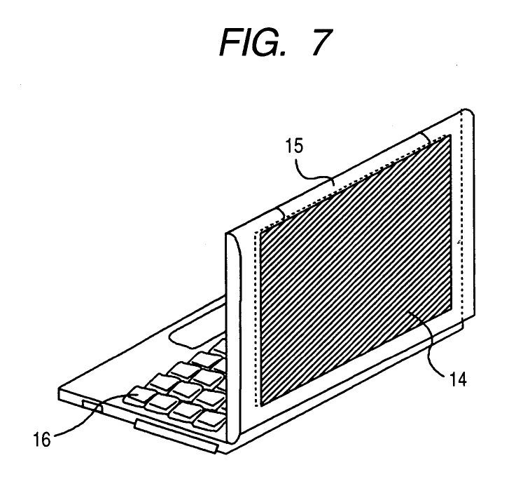

In the present embodiment shown in FIG. 1, two sheets of membrane electrode assemblies (hereunder referred to as “MEAs 4”) which constitute the main part of a fuel cell are arranged in parallel. The MEA 4 comprises a solid polymer electrolytic membrane being interposed between an anode (located on the lower side of the MEAs 4 in FIG. 1) for oxidizing methanol and a cathode (located on the upper side of the MEAs 4 in FIG. 1) for reducing oxygen. It is preferable that the MEA 4 has a nearly square shape from the viewpoints of the easiness of production and the capability of maintaining a uniform contact pressure for a long period of time. In the fuel sell-power supply module comprising plural fuel cells, the more the number of cells, the more voltage generated in the case of connecting the cells in serial. Then the loss, at the time of multiplying voltage with a DC-DC converter 13 (shown in FIG. 6) up to the operation voltage of an electronic device such as a cellular phone, decreases. In this context, a larger number of cells is preferable. On the other hand, the less the number of cells, the more packing density of an electrode part, also the more a per-cell generated electricity amount, and the less contact resistance of terminals for connecting the cells to each other. In this context, a smaller number of cells is preferable. A preferable number of cells is 2 to 6 in consideration of the above two cases. When cells are incorporated into a cellular phone, the aspect (length-to width) ratio of the cell is about 2 to 1, and MEAs of a nearly square shape are adopted, by selecting two cells, the cells well fit the casing of the cellular phone and the space of the cellular phone can be effectively used. When cells are allocated on both sides of a fuel transporter 8, it is preferable to select four cells.

On both the sides of MEAs 4, gaskets 5 are disposed along the peripheries of the MEAs. The gaskets 5 prevent fuel from leaking through the peripheries of the MEAs 4. The gaskets are also useful in putting an anode-current collector 6 and a cathode-collector 2 in contact with the anode and the cathode respectively at an as uniform and constant contact pressure as possible. The cathode-current collector 2 and the anode-current collector 6 are slits for allowing air and fuel to pass through respectively.

In the case of the present embodiment, the fuel to be fed to the anode is methanol and exists as a methanol aqueous solution. The methanol aqueous solution is fed to the anode through a fuel inlet 10, a fuel transporter 8 and a fuel feeder 7.

Here, both the fuel feeder 7 (a first porous member) and the fuel transporter 8 (a second porous member) are made of porous materials but the pore diameter of the fuel feeder 7 is smaller than that of the fuel transporter 8. The smaller a pore diameter, the more capillary force increases, and the stronger a liquid can be wicked. In contrast, the more a pore diameter, the more the rate of fuel transport increases and it is possible to spread a liquid in a whole porous material in a shorter period of time. A preferable ratio between the pore diameters of both the porous materials is 2 to 100, and yet preferably 3 to 50. In the case of the present embodiment, by combining the fuel feeder 7 having a smaller pore diameter with the fuel transporter 8 having a larger pore diameter, the fuel can be rapidly impregnated into the whole fuel transporter, and also the fuel with a strong capillary force is wicked from the contact plane between the fuel feeder 7 and the fuel transporter 8 toward the fuel feeder 7. When the fuel in the fuel feeder 7 is fed, reacted with, and consumed at the anode, the pressure in the fuel feeder 7 becomes a negative pressure in proportion to the volume of the consumed fuel and the fuel is wicked from the fuel transporter 8 to the fuel feeder 7 and fed to the anode to the extent of the consumed volume. As a result, only the fuel corresponding to the consumed volume is fed to the anode, and hence the methanol concentration in the fuel reaching an electrolytic membrane becomes lower than that in the porous body of the fuel transporter 8, the crossover amount of the methanol passing through the electrolytic membrane decreases, and the output increases.

When it is assumed that a fuel cell according to the present embodiment is mounted on portable equipment such as a cellular phone (as shown in FIGS. 6 and 7), the fuel cell is not fixed in a predetermined direction but rotates or moves in all the directions at the angle of 360 degrees. Then even in such a situation, the fuel must be supplied to an anode without fail.

Meanwhile, when studying about the height (capillary height) where a liquid can be wicked by a capillary force, the capillary height (h) is represented by the following expression.
h=2γ cos θ/r,
where, γ represents the surface tension of a methanol aqueous solution, θ the contact angle between the methanol aqueous solution and a fuel transporter 8, and r the pore diameter of the fuel transporter 8.

When the material of a fuel transporter 8 and the concentration of a methanol aqueous solution are determined, then the values of a surface tension and a contact angle are also determined. Therefore, it may be said that the capillary height (wicking height) is determined by a pore diameter.

When the maximum length of a fuel transporter 8 is larger than a capillary height in the design of the fuel transporter and the direction of the maximum length is vertical, fuel is not sufficiently fed up to the upper part and stable power generation of a fuel cell is not secured. The maximum length of a fuel transporter 8 must be smaller than the maximum length determined by the pore diameter thereof.

Here, the maximum length means the distance between both end points most apart from each other in an object (herein the fuel transporter 8 in this case) to be measured. For example, when the object is a rectangle, its maximum length is the length of a diagonal line and, when the object is a circle, the maximum length is the diameter.

The fuel transporter 8 is not particularly limited as long as it shows capillarity and the pore diameter thereof is larger than that of the fuel feeder 7. As examples of such a material, there are: a communicably foamed organic porous body comprising polypropylene, polyethylene, polyvinyl chloride, acryl, aromatic polyamide, aromatic polyaramid, polysulfone, polyether sulfone, polyether ketone, polyphenylene sulfide, polyamide imide, polyurethane, polystyrene, polyester, epoxy, phenol, silicon, or the like; communicably foamed porous ceramics; a communicably foamed metallic porous body produced by a sintering method, a plating method, a foaming method, or a pressure molding method; and others. Among the communicably foamed porous bodies, a high stiffness communicably foamed porous body having an elastic coefficient of not less than 30 kN/cm² is preferable from the viewpoints of pressurizing an MEA and maintaining it.

The pore shape of a porous material can be observed with a scanning electron microscope and the shape is generally amorphous in most cases.

Then as an example, a pore diameter is defined as a value obtained by: integrating the area of a pore part by applying image processing or the like to a porous body surface picture taken with a scanning electron microscope; replacing the area with the identical circular area; and converting the replaced area into a pore diameter. And the pore diameter is defined as the average of the obtained pore diameters. Note that surface observation with a scanning electron microscope is sometimes hardly applicable to an insulative material and hence another method may be adopted for an insulative material in some cases. That is, it is possible to estimate the cross-sectional area of a pore by: filling the interior of the pore with an electrically conductive resin by pressurized injection; and thereafter observing the electrically conductive resin with a scanning electron microscope.

In the present embodiment, for example, the fuel transporter 8 is made of a sintered metallic porous body. In such a case, the concentration of the methanol aqueous solution used for the fuel cell is 30% by weight, and hence the contact angle between the methanol aqueous solution and the porous body is 45 degrees and the surface tension of the aqueous solution is 56 dyn·cm. A graph of the relationship between a capillary height and a pore diameter in this case is shown in FIG. 4.

In the case of the present embodiment, since the maximum length of the fuel transporter 8 is 16 cm, the pore diameter of the fuel transporter 8 must be 60 μm or less and thus an average pore diameter of 58 μm is adopted. As the fuel feeder 7, a polyurethane porous body having an average pore diameter of 9 μm is used. When a sintered metallic porous body is used as the fuel transporter 8, the fuel feeder must be made of an insulative material.

If the maximum length of the fuel transporter 8 is shorter than that of an anode, a part of the anode cannot be covered with fuel transporter, and hence it is impossible to supply fuel sufficiently to the whole anode and to generate electricity stably. For that reason, the maximum length of the fuel transporter 8 must be at least not shorter than the maximum length of the anode.

Here, with regard to the maximum length of an anode, when one anode is installed in the fuel cell, the diagonal line of the anode may be used as the maximum length thereof. When plural anodes are installed in the fuel cell, it is necessary to obtain the maximum length by measuring the whole of the plural anodes after designing the fuel cell so as to arrange the plural anodes on a plane.

A cathode end plate 1 is provided with plural slits for taking in air from the atmosphere. The shape of each slit is not particularly limited but it is preferable that the longitudinal direction of the slit is nearly perpendicular to the longitudinal direction of the cathode end plate 1. Thereby the strength of the cathode end plate against bending increases. An anode end plate 9 constitutes the fuel cell casing together with the cathode end plate 1. The anode end plate 9 is joined with the cathode end plate 1 by screwing thirteen screws into thirteen tapped holes formed at the edge. By tightening the cathode end plate 1 and the anode end plate 9 with the screws, the cathode-current collector 2 and the anode-current collector 6 are interposed between both the end plates, and contact with the MEAs 4 in a pressurized manner. The region crowded with slits as air through holes in the cathode end plate 1 is concaved from the upper face of the edge of the cathode end plate 1. Water produced at the cathode turns into water vapor and is released into the atmosphere. However, if there no consideration under some conditions of outside temperature and humidity, the water vapor condenses on the surface of the cathode end plate 1 and prevents oxygen from dispersing to the cathode. As a result, the power generation output may decrease, namely a so-called flooding phenomenon may occur, and the output of the fuel cell may not be stabilized. To cope with the problems, it is possible to solve the flooding phenomenon caused by the condensed water by placing a hygroscopic quick-drying material (not shown in the figures) in the above-mentioned concaved region. The hygros copic-drying material, for example, has a thickness close to the depth of the concaved region so as to fit the concave of the region. The hygros copic-drying material is capable of absorbing and keeping the condensed water when water condensation occurs. Once the htgros copic-drying material is provided with slits capable of matching for the slits of the cathode end platel by stamping or cutting, it is possible to sufficiently feed oxygen to the cathode. It is also acceptable to stamp the cathode end plate to form circles therein instead of slits. In this case, it is preferable that the circles have an aperture ratio of about 30% to 50%. It is further acceptable to use a low density hygroscopic quick-drying material instead of stamping or cutting slits. The hygroscopic quick-drying material has functions of not only collecting and retaining the condensed water by the capillary force but also evaporating it to the outside atmosphere. When the outside air dries and successively the electrolytic membrane begins to dry, the water retained in the hygroscopic quick-drying material is released as water vapor and the humidity is kept constant. That is, the damages of the electrolytic membrane caused by the contraction and expansion resulted from dry and wet can be reduced, the electrolytic membrane is always in the state of wet, and a stable high output can be obtained immediately when fuel is fed.

As such a hygroscopic quick-drying material, specifically: a material having a double-layered structure (a water conveyance layer and a diffusion layer) or a multi-layered structure (a water absorbing layer, an intermediate layer, and a diffusion layer); or a woven textile or a nonwoven textile of fiber having a porous structure or a hollow structure is used. Further, when hollow fiber having a porous structure in addition to a hollow structure is used, moisture tends to evaporate and the fiber dries rapidly. In this case, moisture is taken in the hollow parts through the fine pores of the porous material. In contrast to this, when evaporating the moisture, the evaporated water follows the reverse path of the above-mentioned moisture path. Further, in the hollow structure, the surface side thereof may have water-repellent and the back side may have water-absorbency. As concrete examples, there are Lumiace (made by Unitika, Ltd.), Aquastealth (made by Kanebo Gohsen, Ltd.), Welkey (made by Teijin, Ltd.), Venroft (made by Toyobo, Ltd.), Spacemaster (made by Kuraray Co., Ltd.), WaterMagic (made by Kuraray Co., Ltd.), Technofine (made by Asahi Kasei Corporation), Technostar (made by Asahi Kasei Corporation), Aege (made by Mitsubishi Rayon Co., Ltd.), Triactor (made by Toyobo, Ltd.), Ceo alpha (made by Toray Industries, Inc.), Kuskus (made by Toyobo, Ltd.), Colax and Swift (made by Mitsubishi Rayon Co., Ltd.), Sofista (made by Kuraray Co., Ltd.), Cortico (made by Teijin, Ltd.), Kilatt (made by Kanebo Gohsen, Ltd.), a high-order complex multilayer-structured yarn (made by Toyobo, Ltd.), Spinair (made by Kurabo Industries, Ltd. and Kuraray Co., Ltd.), and a polyester/cupra conjugated yarn (made by Asahi Kasei Corporation). In the present embodiment, Lumiace (made by Unitika, Ltd.) was used.

The concave of the cathode end plate 1 forms a projection on the other side thereof. The projection makes it possible to more strongly pressurize the cathode-current collector 2 against the cathode when the cathode end plate joins with the anode-current collector 6. As a result, the contact resistance between the cathode-current collector 2 and the cathode decreases and the output of the fuel cell increases. The anode end plate 9 is provided with a concave for containing the fuel feeder 7 and the fuel transporter 8 (refer to FIG. 1). The concave also serves as a fuel tank for storing a methanol aqueous solution.

The cathode end plate is provided with a fuel inlet 10 for taking in a methanol aqueous solution as fuel to a fuel tank. A lid for preventing the fuel from leaking is attached at the fuel inlet 10 although it is not shown in the figures.

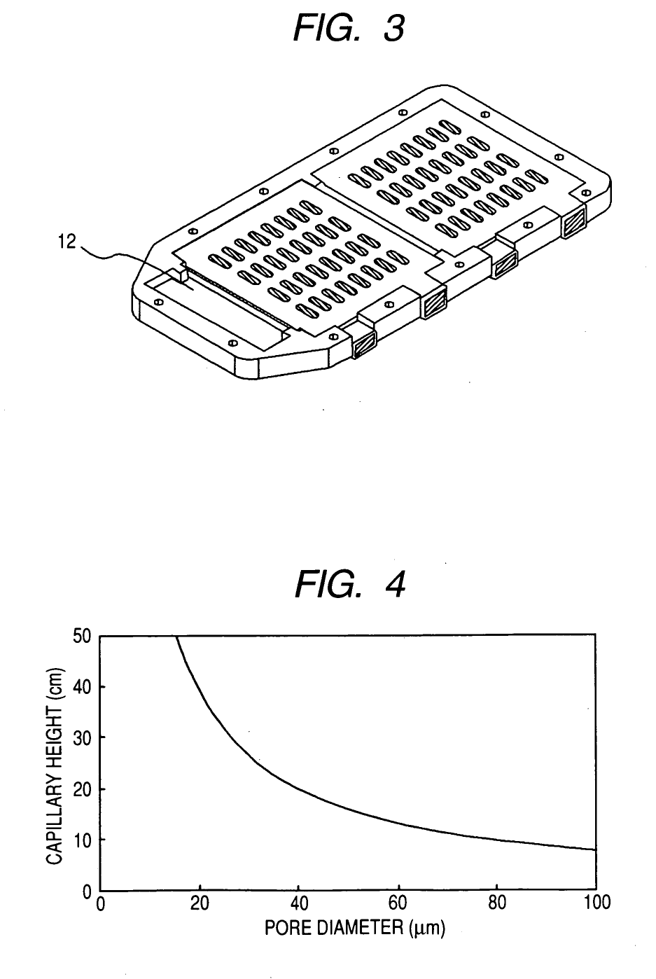

The fuel tank (concave) of the anode end plate 9 is designed so that the longitudinal length thereof may be somewhat longer than the longitudinal length of two MEA sheets. Thus, in the fuel tank of the anode end plate 9, an empty space 12 (shown in FIG. 3) is left near to the MEA section, and the space 12 is serves as a fuel receiving space for taking in fuel the fuel inlet 10. Additionally the longitudinal length of the fuel transporter 8 is also somewhat longer than that of two MEA sheets to fit into the fuel take. Thus, the fuel transporter 8 extends to the fuel receiving space, thereby incoming fuel is rapidly filled the whole fuel tank. The cathode-current collector 2 and the anode-current collector 6 are approximately square, and output terminals 11 are formed at parts thereof.

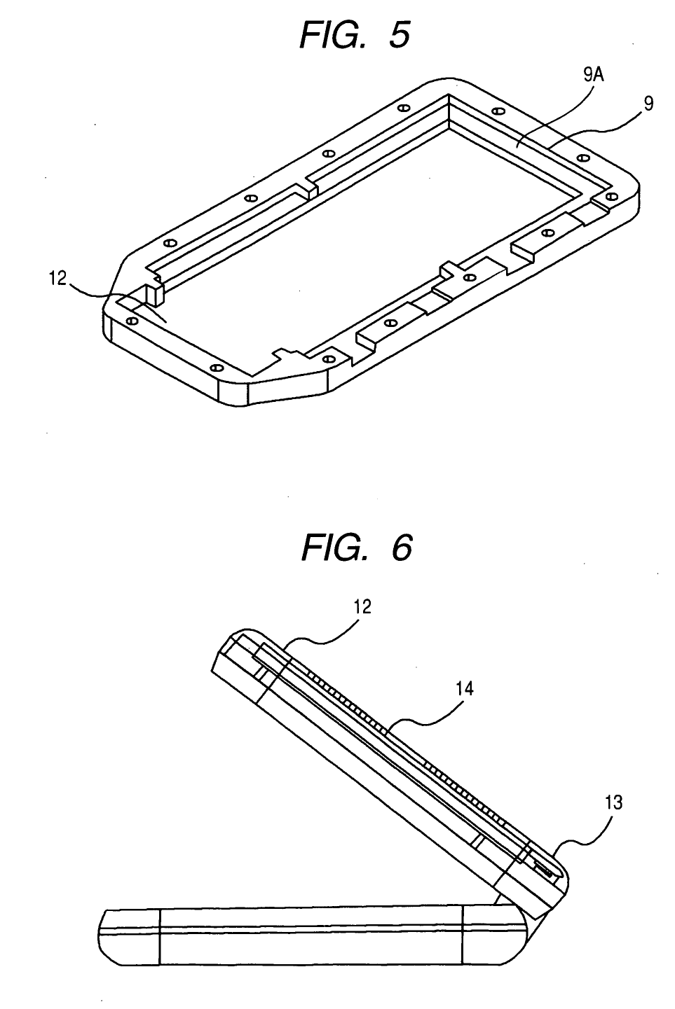

FIG. 2 is a perspective view showing a whole fuel cell in the state of tightly assembling parts ranging from the anode end plate 9 to the cathode end plate 1 shown in the exploded view of FIG. 1. The output terminals 11 of the current collectors are formed on a side of the fuel cell. It is preferable to arrange the output terminals 11 for the anode-current collector and the cathode-current collector respectively on a side of the fuel cell casing for each MEA. Thereby it is possible to execute a check with regard to malfunction for each MEA during operation. FIG. 5 shows a view wherein the cathode end plate is removed from the view shown in FIG. 2. The anode end plate 9-sharp edges on the fuel receiving space 12 side are removed to reduce the size and weight of the fuel cell. An inside wall of the anode end plate 9 is provided with a step-height 9A except for the fuel receiving space 12, and thereby two-step concave structure is formed in the anode end plate 9. In the two-step concave, a deeper concave section with reference to the step-height 9A is to contain the transporter 8 and fuel feeder 8 which are made of insulative capillary material. The shallower concave section with reference to the step-height 9A is to contain the anode-current collector 6, the gasket 5, the MEAs 4, the other gasket 3, and the cathode-current collector 2 in the above-listed order.

FIG. 6 is a view showing a cellular phone in which a fuel cell according to the present embodiment is installed. In the case of installing a fuel cell to a cellular phone, it is preferable to install the fuel cell so that the fuel receiving space 12 may be located on the upper side when a user uses the display of the cellular phone. The reason is as follows. The whole fuel tank is filled with the fuel from the fuel receiving space 12 through the capillary material. In that case, when the fuel receiving space is located on the upper side, the fuel tank can be filled rapidly with the fuel by the help of the gravity. Further, it is preferable that a DC/DC converter 13 is placed under the fuel cell. The reason is as follows. Operation buttons of the cellular phone are usually located under the liquid crystal display, a controller is located on the rear side thereof. Hence, by placing the DC/DC converter 13 at the lower part of the fuel cell, the DC/DC converter can be positioned close to the controller. The fuel cell could produce electricity stably for five hours by supplying a fuel having a concentration of 40% by weight.

FIG. 7 is a view showing a notebook personal computer in which a fuel cell according to the present embodiment is installed. The fuel cell 14 is placed on the back side of the liquid crystal display panel. When the fuel cell is installed in a notebook personal computer, an electric power larger than that of a cellular phone is required and hence eight sheets of MEAs connected in series are used. Fuel is supplied to the fuel cell 14 from a fuel cartridge 15.

A fuel cell according to the present invention is suitably used also for a portable device such as a PDA.

As explained above, according to the present embodiment, a passive type fuel cell is comprised of an anode for oxidizing a liquid fuel, a cathode for reducing oxygen, a solid polymer electrolytic membrane interposed between the anode and the cathode, a current-collector for collecting extract electrons accompanying the power generating reaction from the anode, a first porous material to supply the fuel to the anode, and a second porous member for feeding the fuel to the first porous member. The solid polymer electrolytic membrane, the anode, the current-collector, the first porous member, and the second porous member are layered in the above-listed order. The pore diameter of the first porous material is made smaller than that of the second porous material. Herein, for example, the ratio between the pore diameters of both the porous members is 2 to 100, and preferably 3 to 50. Thus, the ratio enables the second porous member to retain a liquid fuel having a high concentration in the range of 30% to 60% by weight. Thereby, the first porous member can have a transport function, and resulting amount of the fuel transport to the anode can be equal to only an amount of fuel corresponding to the amount consumed at the anode. Hence, it is possible to reduce the amount of the fuel reaching the electrolytic membrane. It can be assumed that the fuel of an apparently low concentration touches the electrolytic membrane. As a result, the power generation of the fuel cell can continue stably for a long period of time.

In addition, the second porous member can sufficiently retain fuel by setting the maximum length of the second porous member larger than the maximum length of the anode but not larger than the value h represented by the following expression. And the fuel can be fed rapidly to the anode by making the size of the first porous member identical to that of the second porous member.
h=2γ cos θ/r,
where, γ: surface tension, θ: contact angle between a methanol aqueous solution and the second porous member, r: pore diameter of the second porous material.

What is claimed is:

1. A fuel cell comprising:
an anode for oxidizing a liquid fuel,
a cathode for reducing oxygen,
a solid polymer electrolytic membrane interposed between the anode and the cathode,
a current collector for collecting electrons produced at the anode,
a first porous member for feeding the fuel to the anode, and
a second porous member for feeding the fuel to the first porous member,
wherein the solid polymer electrolytic membrane, the anode, the current collector, the first porous member, and the second porous member are layered in the above-listed order, and
the pore diameter of the first porous member is smaller than that of the second porous material.

2. The fuel cell according to claim 1, wherein the pore diameter of said second porous member is 20 to 100 μm.

3. The fuel cell according to claim 1, wherein the second porous member is made of a foam sintered metal.

4. The fuel cell according to claim 3, wherein the first porous member is made of an insulative material.

5. A fuel cell comprising:
an anode for oxidizing a liquid fuel,
a cathode for reducing oxygen,
a solid polymer electrolytic membrane interposed between the anode and the cathode, and
a porous member for feeding the fuel to the anode, and
the maximum length of the porous member is larger than or equal to the maximum length of the anode and smaller than or equal to the value h represented by the following expression,
h=2γ cos θ/r,
where, γ: a surface tension, θ: the contact angle between the liquid fuel and said porous material, r: the pore diameter of the porous member.

6. Electronic equipment, wherein the equipment is equipped with a power supply comprising the fuel cell according to claim 1 or claim 5.
